(19) United States
(12) Patent Application Publication
(10) Pub. No.: US 2012/0260954 A1
(43) Pub. Date: Oct. 18, 2012

(54) AIR FILTER CLEANER

(76) Inventors: William Southwell, Warren, PA (US); Butch Southwell, Warren, PA (US)

(21) Appl. No.: 13/444,954

(22) Filed: Apr. 12, 2012

Related U.S. Application Data
(60) Provisional application No. 61/474,419, filed on Apr. 12, 2011.

(51) Int. Cl. B08B 3/02

(52) U.S. Cl. 134/33; 134/138

(57) ABSTRACT

In accordance with one aspect of the present exemplary embodiment, a portable air filter cleaning device is provided. The device comprises a support frame including at least two legs and a rotatable air filter receiving frame defining a perimeter. The rotatable air filter receiving frame is supported by the support frame. A tube having a first end adapted to receive a water line and a second end including a plurality of outlets is also provided. The second end of the tube is oriented to direct water from the outlets toward the air filter receiving frame perimeter so that water ejected from the outlets impacts a washable air filter mounted upon the air filter receiving frame and causes rotation thereof.

### BACKGROUND

The present invention is directed to an air filter cleaner. More particularly, the present invention is directed to an air filter cleaner which may be used at a remote site to clean the washable air filters of vehicles. One particular application can be directed to dirt track racing vehicles.

Automobiles and other vehicles and machines having similar engines typically employ filtering medium which allows for passage of air but traps the particulates on its outer surface to prevent dust and other particles from air entering the engine. Woven cotton is one commonly employed washable material used to construct air filters. These washable filters usually have an annular or cylindrical shape. As recommended by the manufacturer, these types of washable air filters are treated with an oil spray prior to engine use, which helps to absorb the dust and dirt in the air. In ordinary use these filters become clogged with accumulated dust, dirt, and oil, potentially choking off air supply to the engine, reducing power and increasing fuel consumption. Dirt may even be forced through the filter into the engine, causing damage to moving parts. Thus, air filters require replacement or cleaning on a regular basis.

When the engine is in use under extreme conditions, for example vehicles used in a desert or an otherwise extremely dusty environment, an even greater frequency of replacement or cleaning is needed. Since replacement is relatively expensive, it would be advantageous if the filter could be effectively cleaned to avoid the need for frequent replacement.

If possible, it is preferable to clean the filter rather than replace it, both from a cost standpoint for the consumer and for the benefit of passing fewer discarded units into the waste stream, thereby reducing the land fill accumulation by hundreds of thousands of units. The washable cotton filter is a particular focus of the present disclosure.

### BRIEF DESCRIPTION

In accordance with one aspect of the present exemplary embodiment, a portable air filter cleaning device is provided. The device comprises a support frame including at least two legs and a rotatable air filter receiving frame defining a perimeter. The rotatable air filter receiving frame is supported by the support frame. A tube having a first end adapted to receive a water line and a second end including a plurality of outlets is also provided. The second end of the tube is oriented to direct water from the outlets toward the air filter receiving frame perimeter so that water ejected from the outlets impacts an air filter mounted upon the air filter receiving frame and causes rotation thereof. This rotation creates a centrifugal force which drives the dirt and debris out of the filter.

### BRIEF DESCRIPTION OF THE DRAWINGS

FIG. 1 is an end view of the air filter cleaner with the filter removed;

FIG. 2 is a side view of FIG. 1;

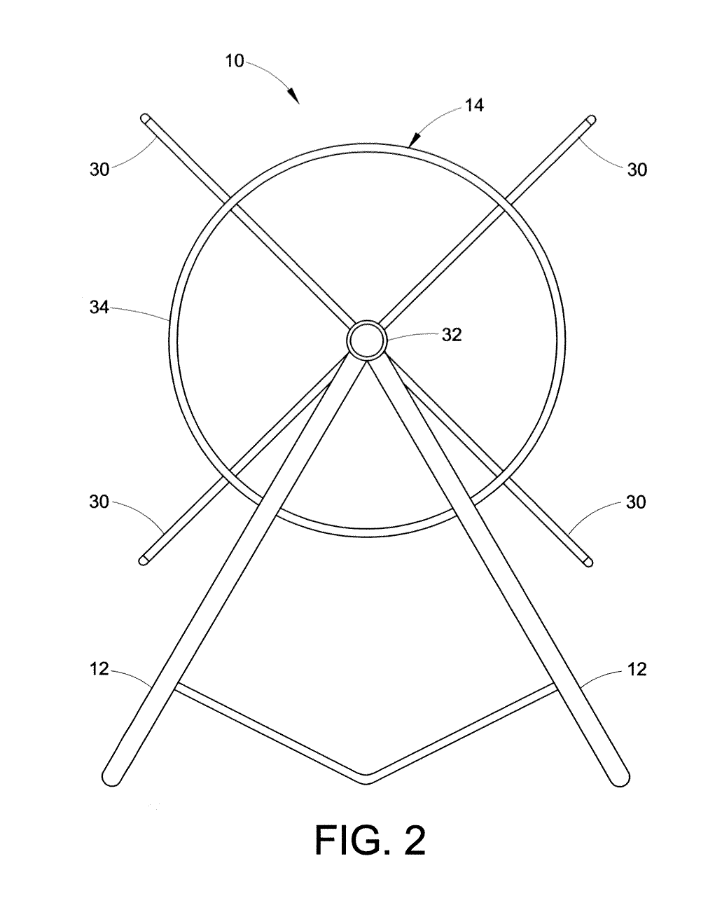

FIG. 3 is a photograph of a front elevation view of he present air filter cleaner having an air filter mounted thereon; and

FIG. 4 is a perspective view photograph of the design of FIG. 3.

### DETAILED DESCRIPTION OF THE DRAWINGS

Referring now to the FIGURES, an air filter cleaner 10 is illustrated. Air filter cleaner 10 includes a pair of cooperative legs 12 having a generally “L” shaped configuration and spaced from one another in a suitable manner to provide a stable support for a rotatable air filter receiving frame 14. As shown, an angle of approximately 60° is one example of a spacing that provides adequate stability. It is also feasible to provide each leg 12 with a forward inclination in its vertical component (for example 10-20°) to achieve orientation of the air filter receiving frame 14 above a generally central axis of the horizontal base portions of legs 12.

Each of legs 12 is mated to a collar 16, preferably via weldment. Collar 16 fixedly receives tube 18 having a first end including a connection 20 to a water supply line. An exemplary connection i a male or e screw connection suitable for mating with a standard hose fitting.

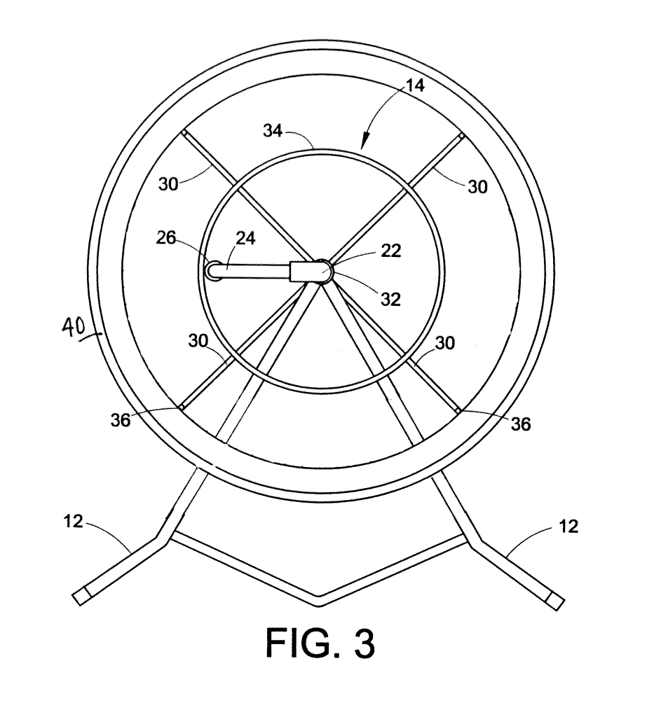

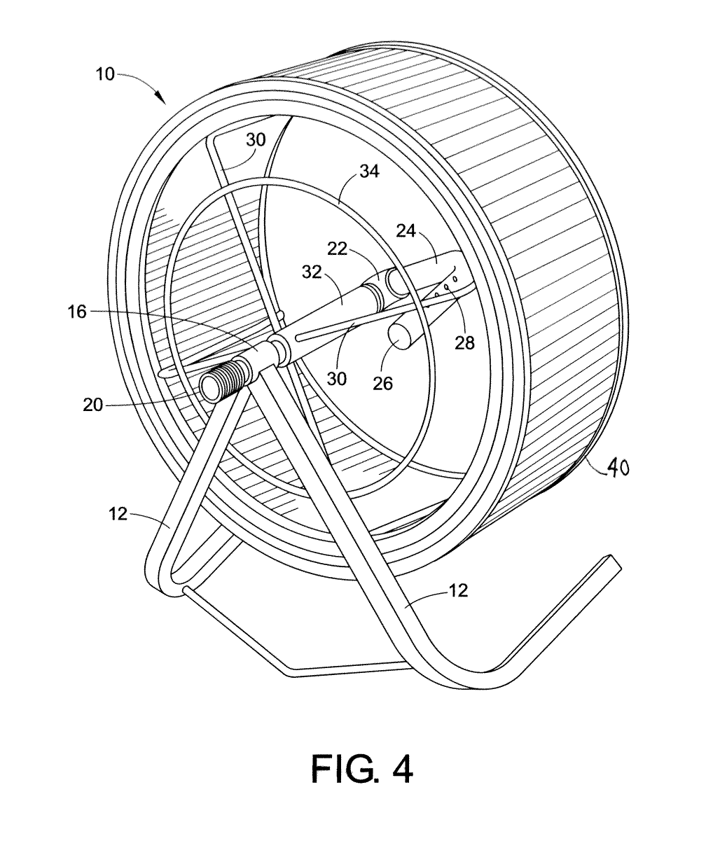

Tube 18 extends to a second end which mates with an elbow member 22 which mates with an outlet member 24. Outlet member 24 similarly provides a 90° turn and terminates in a cap member 26. Alternatively, the end of outlet member 24 can be sealed by welding or other means known to the skilled artisan. As shown in FIGS. 3 and 4, it is also feasible to form outlet member 24 from multiple pieces such as a straight and elbow components. A plurality of outlet holes 28 are provided in the outlet member 24. The outlet member 24 is oriented such that holes 28 face the periphery of the air filter receiving frame 14.

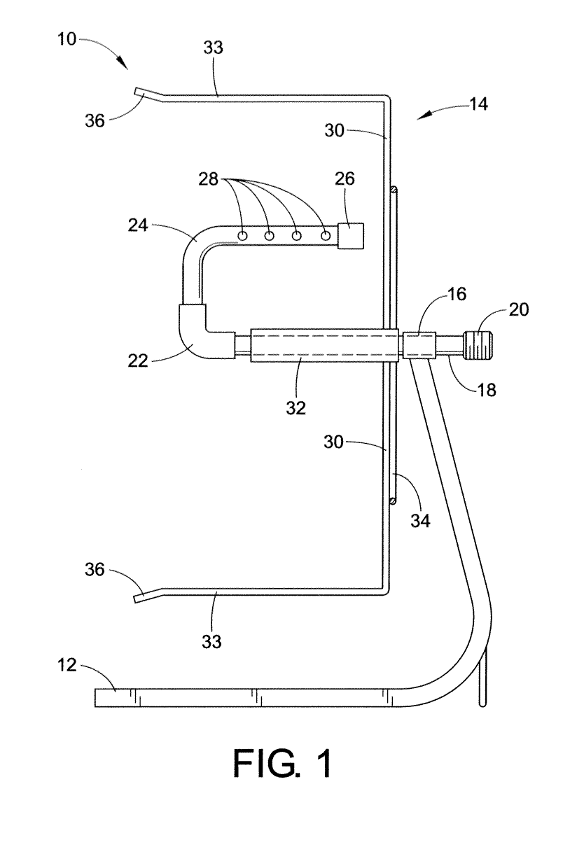

With further reference to air filter receiving frame 14, it comprises four radially extending members 30 secured via weldment to a metal tube 32 rotatably mounted upon tube 18. Horizontally extending arms 33 create a frame perimeter that receives the air filter 40. Frame 14 further includes a stabilizing ring 34. As shown in FIG. 1, terminal portions 36 of horizontal arms 33 can include an outwardly inclined tip portion to facilitate retention of the air filter once slid thereover.

Referring now to FIGS. 3 and 4, a washable air filter is mounted to the horizontally disposed arms of the frame member. In operation, the force exerted by the expelled water impacting the washable air filter is sufficient to create a rotational force thereon, such that the air filter rotates repeatedly 360° exposing the entirety of the inner surface of the air filter to impact from the outlet water jets.

Vibration caused by the water jets, plus the reverse water flow through the filter and the centrifical force of its rotation, will cause accumulated dust and dirt to be forced outwardly from the filter. This arrangement will achieve satisfactory spin velocities when connected to a standard water hose. The operation is fast and the washable filter can be cleaned quickly, easily, and safely, without damaging the filter. Thus, filter lifetime can be extended.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A portable air filter cleaning device comprising;
a support including a base and a rotatable air filter receiving frame defining a perimeter supported by said base;
a tube having a first end adapted to receive a water line and a second end including a plurality of outlets, said second end oriented to direct fluid from said outlets toward the air filter receiving frame wherein fluid ejected from said outlets impacts an associated air filter mounted upon said air filter receiving frame and causes rotation thereof.

2. The portable air filter cleaning device of claim 1 wherein the support includes a collar attaching the structural base to the tube.

3. The portable air filter cleaning device of claim 1 wherein the support includes a disc member attaching the rotatable air filter receiving frame to the tube.

4. The portable air filter cleaning device of claim 3 wherein the disc member is fixedly attached to the rotatable air filter receiving frame and the disc member is rotatably attached to the tube.

5. The portable air filter cleaning device of claim 1 wherein the base includes at least two legs.

6. The portable air filter cleaning device of claim 5 wherein the at least two legs are configured such that a first leg is radially spaced from the second leg at an angle between approximately 30 and 60 degrees.

7. The portable air filter cleaning device of claim 5 wherein the at least two legs include a horizontal base portion and a vertical component arranged in an L shaped configuration.

8. The portable air filter cleaning device of claim 7 wherein the vertical component of each leg includes a general forward inclination to position the air filter receiving frame above a generally central axis of the horizontal base portion of the legs.

9. The portable air filter cleaning device of claim 1 wherein the tube includes an elbow member between the first and second ends.

10. The portable air filter cleaning device of claim 1 wherein the rotatable air filter receiving frame includes a plurality of radially extended members each having a horizontally extending arm to create a frame perimeter that receives an associated filter.

11. The portable air filter cleaning device of claim 10 wherein the air filter receiving frame includes at least four radially extending members having a first end attached to the disc member and an oppositely disposed second end attached to the horizontally extending arm.

12. The portable air filter cleaning device of claim 10 wherein each horizontally extending arm is attached to the radially extended member at a first end and includes an oppositely disposed second end having an outwardly inclined tip portion.

13. The portable air filter cleaning device according to claim 10 wherein a stabilizing ring is positioned on the frame to support the plurality of radially extended members.

14. A method of cleaning an air filter comprising:
mounting a washable air filter to a rotatable frame of an air filter cleaning device;
introducing fluid through a first end of a tube of the air filter cleaning device;
expelling fluid through a second end of the tube such that the fluid impacts an inner surface of the air filter; and
simultaneously rotating the frame and air filter thereon relative to the tube such that the expelled fluid impacts along a perimeter of the rotatable frame and causes dust or dirt particles to be forced outwardly from the filter.

15. The method of cleaning an air filter of claim 14 further comprising the step of increasing a fluid pressure by expelling fluid through a plurality of holes on the second end of the tube.

16. A portable air filter cleaning device comprising:
a support frame including a structural base and a rotatable air filter receiving frame defining a perimeter supported by said structural base;
a tube having a first end adapted to receive a water line and a second end including a plurality of outlets, said second end oriented to direct fluid from said outlets toward, the air filter receiving frame; and
a disc member is fixedly attached to the rotatable air filter receiving frame and rotatably attached to the tube such that the rotatable air filter receiving frame is rotatable relative to the tube wherein fluid ejected from the outlets impacts an associated air filter mounted upon said air filter receiving frame and causes rotation thereof.

17. The portable air filter cleaning device of claim 16, wherein the disc member has an elongated cylindrical shape and is concentrically positioned on the tube.

18. The portable air filter cleaning device of claim 17, wherein the rotatable air filter receiving frame is configured to support a generally circular shaped air filter.

19. The portable air filter cleaning device of claim 17, wherein the rotatable air filter receiving frame comprises a plurality of radially extended members each having a horizontally extending arm to create a frame perimeter to receive and support an associated filter, each radially extended members having a first end attached to the disc member and an oppositely disposed second end attached to the horizontally extending arm.

20. The portable air filter cleaning device of claim 19, wherein the rotatable air filter receiving frame includes a stabilizing ring attached to the plurality of radially extended members and is concentrically located around the disc member.
